(19) United States
(12) Patent Application Publication
(10) Pub. No.: US 2025/0197058 A1
(43) Pub. Date: Jun. 19, 2025

(54) TOOL STORAGE CASE AND SYSTEM

(71) Applicant: Klein Tools, Inc., Lincolnshire, IL (US)

(72) Inventors: Cameron Knauth, Mansfield, TX (US); Austin Minor, Aledo, TX (US)

(73) Assignee: Klein Tools, Inc., Lincolnshire, IL (US)

(21) Appl. No.: 18/978,885

(22) Filed: Dec. 12, 2024

Related U.S. Application Data
(60) Provisional application No. 63/609,555, filed on Dec. 13, 2023.

(51) Int. Cl. B65D 21/02; B25H 3/00; B25H 3/02; B65D 43/16; B65D 43/22

(52) U.S. Cl. CPC B65D 21/0212; B25H 3/021; B65D 43/163; B65D 43/22; B25H 3/003

(57) ABSTRACT

A tool storage case system includes a pair of storage cases that can be releasably connected to each other by a latch that extends rearwardly from an exterior side of a back wall of one of the cases no further than a pair of hinges of the case. The latch is located between the pair of hinges and is mounted to the back wall to pivot between a latched position and an unlatched position, with the latch extending rearwardly no further than the pair of hinges with the latch in the latched position.

### CROSS-REFERENCE TO RELATED APPLICATIONS

This application claims priority to U.S. Application Ser. No. 63/609,555 filed Dec. 13, 2023, titled “Tool Storage Case and System”, the entire disclosure of which is incorporated herein by reference.

### BACKGROUND OF THE DISCLOSURE

The present disclosure relates containers or cases used to store tools, especially hand tools and components such as, for example, screw drivers, driver bits, driver sockets, adaptors, power nut drivers, ratchet wrenches, socket wrenches. It is known to provide two or more such cases with structures that allow the cases to be releasably connected when the cases are stored in a closed position. While such known cases are suitable for their intended purpose, there is always room and desire for improvement.

### BRIEF SUMMARY OF THE DISCLOSURE

In accordance with one feature of this disclosure, a tool storage case system includes a pair of storage cases that can be releasably connected to each other. Each storage case defines an interior storage space and includes a first housing member, a second housing member, a pair of hinges, a latch and a latch engagement structure. The first housing member has a first connection structure, a first back wall, a first front wall, a pair of first side walls extending between the first front and first back wall, and a first base wall extending between the first wall, the first back wall and the pair of first side walls. The second housing member has a second connection structure, a second back wall, a second front wall, a pair of second side walls extending between the second front and second back wall, and a first base wall extending between the second wall, the second back wall and the pair of second side walls. The pair of hinges extends rearwardly from the first and second back walls and joining the first and second housing members to pivot relative to each other between an open position wherein the interior storage space can be accessed and a closed position wherein the interior storage space is enclosed by the housing members. The pair of hinges are located on an exterior side of each of the first and second back walls. The latch extends rearwardly from the exterior side of the second back wall no further than the pair of hinges. The latch is located between the pair of hinges and mounted to the second back wall to pivot between a latched position and an unlatched position. The latch extends rearwardly no further than the pair of hinges with the latch in the latched position. The latch engagement structure is located on the exterior side of the first back wall between the pair of hinges. The pair of storage cases can be releasably connected to each other with the first connection structure of one of the storage cases of the pair of storage cases engaged with the second connection structure of the other storage case of the pair of storage containers, and the latch of the one of the storage cases of the pair of storage cases engaged with the latch engagement structure of the other storage case with the latch in the latched position.

As one feature, the first connection structure of each storage case includes a pair of spaced cleats formed on the exterior side of the first base wall; and the second connection structure of each storage case includes a pair of spaced receptacles formed on the exterior side of the second base wall that are sized to receive the pair of spaced cleats. In a further feature, each of the cleats extends from the first base wall at a location adjacent the first front wall; and each of the receptacles extends from the second base wall at a location adjacent to the second front wall. In yet another feature, each of the cleats extends above a recess formed in the first front wall; and each of the receptacles is formed in a tab that is received in a corresponding one of the recesses with a corresponding one of the cleats received in the receptacle.

As one feature, each storage case of the pair of storage cases further including a pair of spaced tongues extending from the second back wall. The tongues of one of the storage cases of the pair of storage cases are located to closely overlay a portion of the first back wall of the other storage case of the pair of storage cases with the pair of storage cases releasably connected to each other.

In one feature, each storage case of the pair of storage cases further includes an additional latch extending from the first and second front walls with the housing members in the closed position to retain the housing members in the closed position. In a further feature, the additional latch of each storage case of the pair of storage cases is mounted to the second front wall to translate relative to the second front wall between a retaining position wherein the latch retains the first and second housing members in the closed position and a releasing position wherein the first and second housing members can be moved to the open position from the closed position.

As one feature, a single storage case is provided as described in any of the above paragraphs.

It should be understood that the inventive concepts disclosed herein do not require each of the features discussed above, may include any combination of the features discussed, and may include features not specifically discussed above.

### BRIEF SUMMARY OF THE SEVERAL VIEWS OF THE DRAWINGS

FIG. 1 is a perspective view from the front, left side, and above of a tool storage container/case system showing two releasably connected tool storage containers/cases according to this disclosure, with the containers/cases shown in a closed position or condition;

FIG. 2 is a perspective view from the back, right side, and above of the tool storage case system of FIG. 1, again with both of the cases shown in the closed position or condition;

FIG. 3 is a perspective view from the front, right side, and above of the tool storage case system shown in FIGS. 1 and 2, but showing both of the cases in an open position or condition, with a variety of tools stored in the cases;

FIG. 4 is a top plan view of the tool storage case system shown in FIGS. 1-3;

FIG. 5 is a bottom view the tool storage case system shown in FIGS. 1-4;

FIG. 6 is a perspective view from below, right side, and the back showing a selected portion of the tool storage case system of FIGS. 1-5;

FIG. 7 is a perspective view from below, right side, and the front showing a selected portion of the tool storage case system of FIGS. 1-6;

FIG. 8 is a perspective section view taken from line 8-8 in FIG. 4;

FIG. 9 is a perspective section view taken from line 9-9 in FIG. 4;

FIG. 10 is a top plan view showing either one of the cases of FIGS. 1-9 in an open position, with a variety of tools stored in the case;

FIG. 11 is perspective view from the front, left side, and above showing either one of the cases of FIGS. 1-9 in an open position, with another variety of tools stored in the case; and

FIG. 12 is a perspective view from the front, right side, and above showing either one of the cases of FIG. 1-9 in an open position, with yet another variety of tools stored in the case.

### DETAILED DESCRIPTION OF PREFERRED EMBODIMENTS

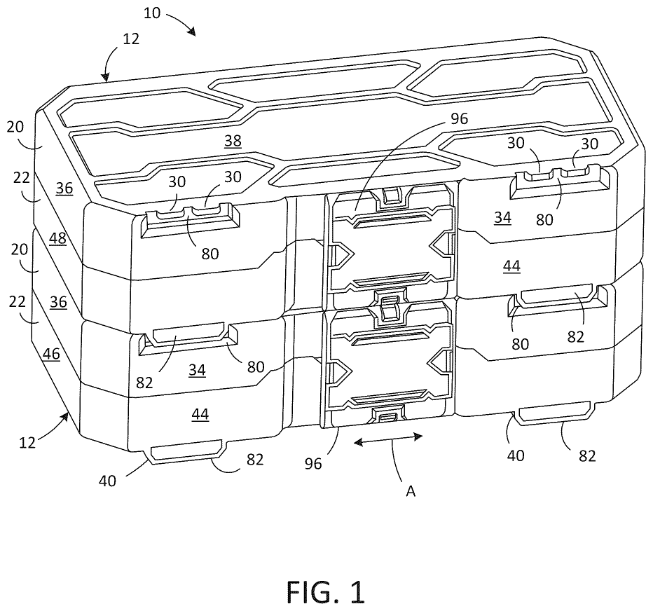

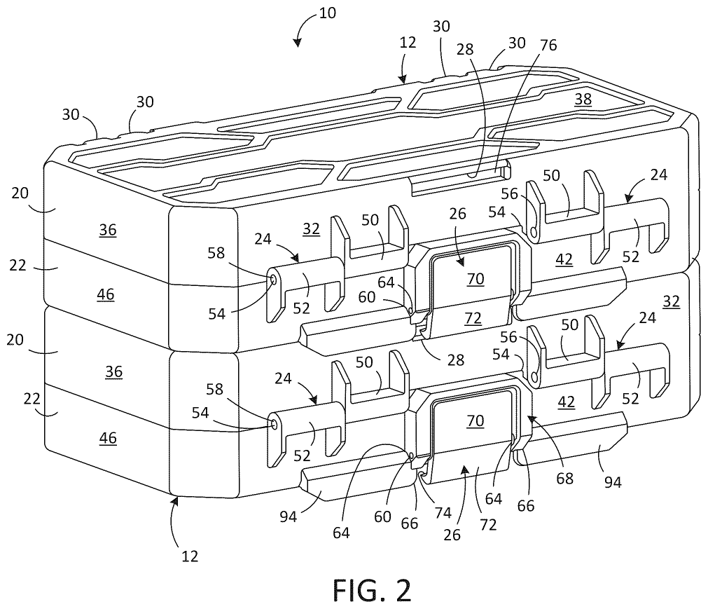

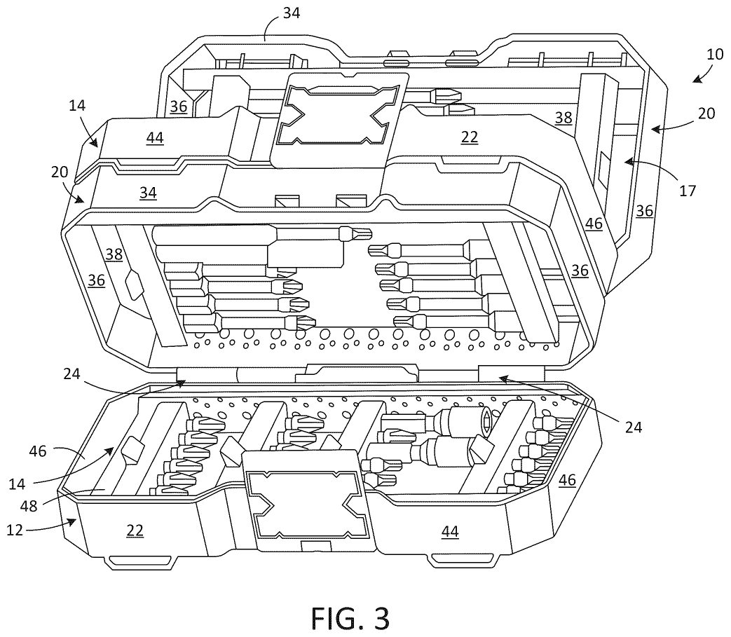

As best seen in FIGS. 1 and 2, a tool storage container or case system 10 includes a pair of tool storage containers or cases 12 that can be releasably connected to each other. As best seen in FIG. 3, each of the cases 12 defines an interior storage space 14 that can store a variety of tools 16.

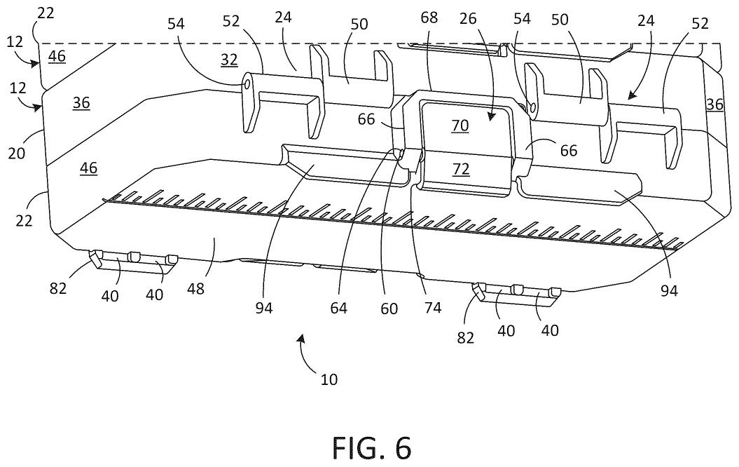

As best seen in FIG. 2, in the illustrated and preferred embodiment, each of the containers includes a first housing member 20, a second housing member 22, a pair of hinges 24, a connecting latch 26, and a latch engagement structure 28. Each of the first housing members 20 has a first connection structure 30, a first back wall 32, a first front wall 34, a pair of first side walls 36 extending between and connecting the first front and back walls 34 and 32, and a first base wall 38 extending between and connecting the walls 32, 34, and 36. Each of the second housing members 22 has a second connection structure 40 (best seen in FIG. 6), a second back wall 42, a second front wall 44, a pair of second side walls 46 extending between and connecting the second front and back walls 44 and 42, and a second base wall 48 extending between and connecting the walls 42, 44, and 46. Each of the first and second housing members 20 and 22 are preferably formed as via a suitable molding process, such as by injection molding, using a suitable material, such as a suitable plastic/polymer.

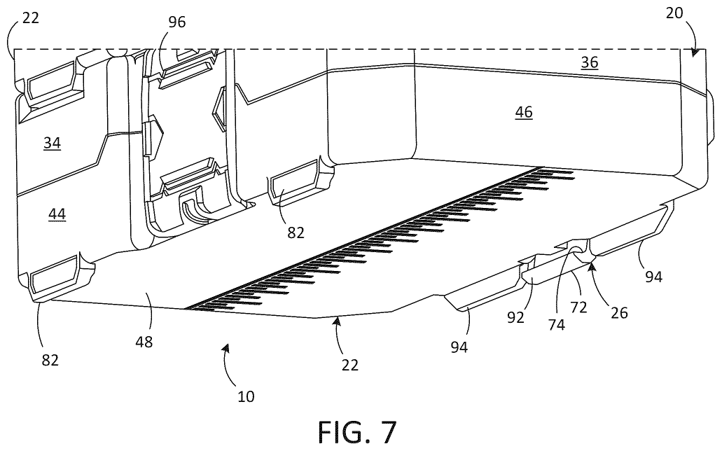

In the illustrated and preferred embodiment, Each of the hinges 24 extend rearwardly from the first and second back walls 32 and 42 and join the first and second housing members 20 and 22 to pivot relative to each other between an open position or positions shown in FIGS. 3 and 10-12 wherein tools stored in the interior storage space 14 can be accessed, and a closed position shown in FIGS. 1, 2, and 4-9 wherein the interior storage space 14 is enclosed by the housing members 20 and 22 so that the tools stored therein cannot be accessed. Each of the hinges 24 extends rearwardly from an exterior side of each of the first and second back walls 32 and 42. In the illustrated embodiment, each hinge 24 includes a first knuckle or barrel 50 extending rearwardly from the first back wall 32, a second knuckle or barrel 52 extending rearwardly from the second back wall 42, and a cylindrical pin 54 extending into bores 56 and 58 formed in the first and second barrels 50 and 52, respectively. Preferably, each of the first barrels 50 is formed as a unitary part of the first housing member 20 during the molding process that forms the first housing member 20, and each of the second barrels is formed as a unitary part of the second housing member 22 during the molding process that forms the second housing member 22. It should be understood that while a specific type and configuration of hinge has been disclosed in the preferred embodiments, in some applications it may be advantageous to utilize a different type or configuration of hinge.

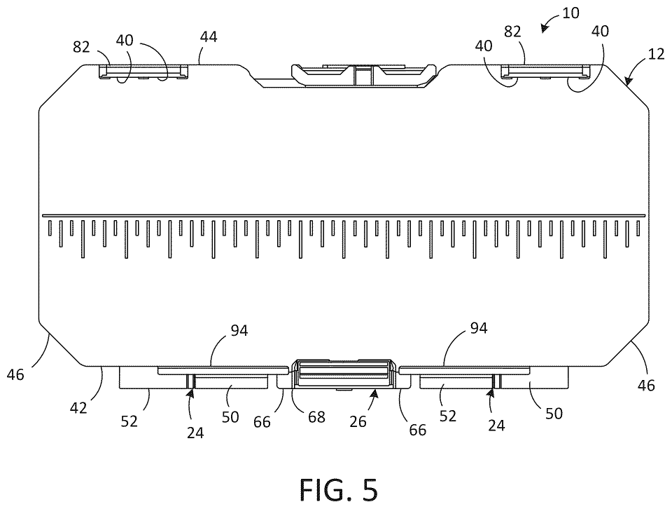

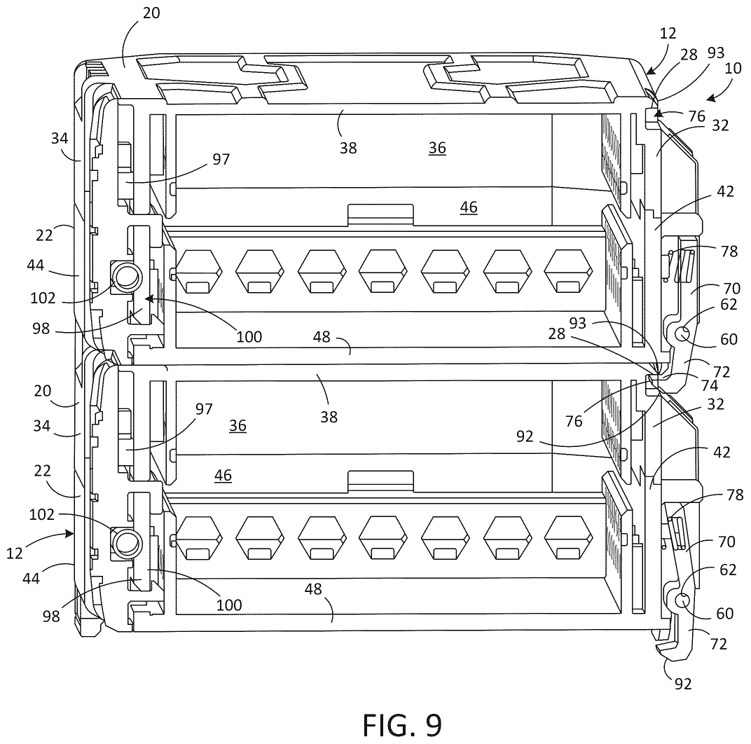

In the illustrated and preferred embodiment, the connecting latch 26 of each case 12 extends rearwardly from the exterior side of the second back wall 42 no further than the pair of hinges 24, as best seen in FIG. 5. The latch 26 is located between the hinges 24 and, in the illustrated and preferred embodiment, is mounted to the second back wall 42 to pivot between a latched position (shown in FIGS. 2, 5-7, and the upper case 12 of FIG. 9) and an unlatched position (as shown in the lower case 12 of FIG. 9). In this regard, in the illustrated and preferred embodiment, a cylindrical pin 60 extends through a pivot bore or journal opening 62 formed in the latch 26, with the opposite ends of the pins being friction fit in receiving bores 64 formed in a pair of ribs 66 extending from the second back wall 42 on opposite sides of the latch 26 and between the hinges 24. The latch pivots about the pin 60 between the latched and unlatched positions. The ribs 66 are part of a U-shaped rib structure 68 that extends rearwardly from the second back wall 42 to surround an upper portion 70 of the latch 26 that serves as a user actuating portion 70 that can be engaged by a finger or fingers of a user to manually actuate the latch 26 from the latched position to the unlatched position. Preferably, the U-shape rib structure 68 is formed as a unitary portion of the second housing member 22 during the molding process used to form the housing member 22. A lower portion 72 of the latch 26 defines an upwardly facing surface 74 that engages the latch engagement structure 28 with the latch 26 in the latched position. In this regard, in the illustrated and preferred embodiment, the latch engagement structure 28 in each of the cases 12 is provided in the form of a downwardly facing surface 28 formed as a unitary part of the first housing member 20 and located in a recess 76 formed in the first housing member 20. As best seen in FIG. 9, in the illustrated and preferred embodiments, each case further includes a biasing member 78 in the form of a helical compression spring 78 that is sandwiched between the exterior side of the second back wall 42 and the upper portion 70 of the latch 26 to bias the latch to the latched position. Again, as best seen in FIG. 5, the rib structure 68 and the latch 26 (in the latched position) extend rearwardly no further than the hinges 24, with the most rearward most part of each of the cases 12 being defined by the barrels 50 and 52 of the hinges 24.

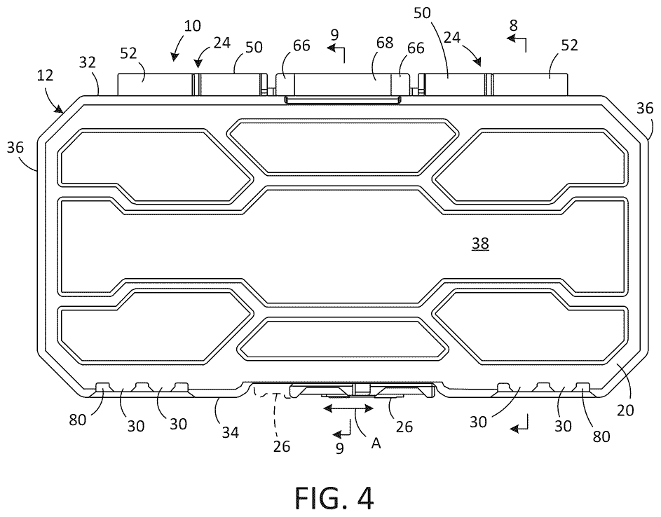

As best seen in FIGS. 1 and 4, in the illustrated and preferred embodiments, the first connection structure 30 in each first housing member 20 is provided in the form four spaced cleats 30 that extend forwardly from the first base wall 38 at a location adjacent the first front wall 34. Two of the cleats 30 extend above a recess 80 formed in the first front wall 34 and two of the cleats 30 extending above another recess 80 formed in the first front wall 34. As best seen in FIG. 4, the cleats 30 do not extend forwardly past the first front wall 34. Preferably, the cleats 30 and recess 80 are formed as unitary portions of the first housing member 20 during the molding process that creates the housing member 20.

As best seen in FIG. 6, in the illustrated and preferred embodiments, the second connection structure 40 in each second housing member 22 is provided in the form of four receptacles 40 formed in a pair of tabs 82 that extend downwardly form the second base wall 48 at a location adjacent to the second front wall 42. Each of the receptacles 40 is located to receive a corresponding one of the cleats 30 on a case that is releasably connected to the second housing member 22, and each of the tabs 82 is sized and configured to be received in a corresponding one of the recesses 80 (best seen in FIG. 1) In the illustrated and preferred embodiment, the tabs 82 can be considered as extensions of the second front wall 42. Preferably, the receptacles 40 and the tabs 82 are formed as unitary portions of the second housing member 22 during the molding process that creates the second housing member 22.

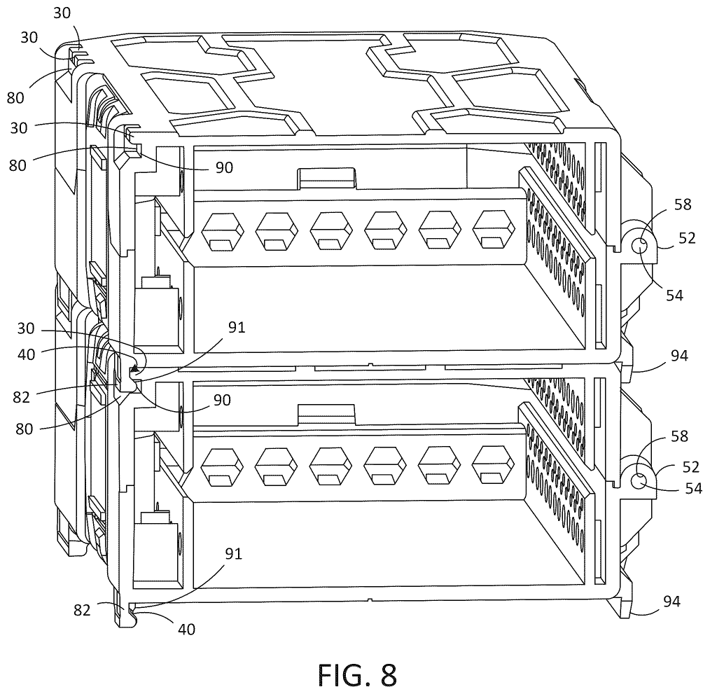

As best seen in FIGS. 8 and 9, when the cases 12 are releasably connected to each other, each of the cleats 30 of the bottom case 12 extend into a corresponding receptacle 40 of the top case 12, and the latch 26 of the top case 12 is in the latched position, with the upwardly facing surface 74 of the latch 26 engaged with the downwardly facing surface 28 to retain the two cases 12 in their connected condition. As best seen in FIG. 8, each of the cleats 30 has a downwardly facing surface 90 that engages an upwardly facing surface 91 in each of the corresponding receptacles 40. To disconnect the two cases 12, a user can press the upper portion 70 of the latch 26 to pivot the latch (counterclockwise in FIG. 9) to the unlatched position, and the two cases are pivoted away from each other, with each of the cleats 30 acting as a pivot point in the corresponding receptacle 40. In this regard, as best seen in FIG. 9, in the illustrated and preferred embodiment, each of the upwardly facing surfaces 91 has a downwardly angled relief to allow the pivoting motion when disconnecting the cases 12 from each other. To reconnect the cases 12, the cleats 30 are engaged in receptacles 40 and the cases are pivoted toward each other to engage the latch 26 with the latch engagement structure 28. In this regard, as best seen in FIG. 9, in the illustrated and preferred embodiments, each latch 26 includes an angled surface 92 and each of the first housing members 20 includes an angles surface 93 that engage each other as the cases 12 are pivoted toward each other to force the latch 26 to first pivot toward the unlatched position before pivoting back to the latched position when the cases 12 are pivoted completely to the connected condition/position.

It should be appreciated that by locating and limiting the latch 26 to the “free” space between the hinges 24, the interior space 14 can be optimized for storage without having to be sacrificed to allow for the latch 26 and without enlarging the overall size or footprint of each of the cases 12.

While only two of the cases 12 are shown in the Figures, it should be easily appreciated by those skilled in the art, that any number of additional cases 12 can be connected to the cases 12 shown in the Figures. It should also be appreciated that although the two cases 12 shown in the Figures are of identical size and have identical exterior features, cases 12 of different sizes and with exterior features that are not identical can still include the first and second connection features 30 and 40 and the latch 26 at locations that allow the non-identical cases to be releasably connected as shown herein.

Optionally, as shown in the illustrated and preferred embodiment, each of the cases 12 can further include a pair of tabs or tongues 94 extending downwardly from the second back wall 42 to overlay the first back wall 32 of the lower case 12 with the cases 12 in the connected condition. The tongues 94 help to prevent the cleats 30 from disengaging from the receptacles 40 with the cases in the connected condition. Preferably, each of the tongues 94 and each of the tabs 82 extend downwardly from the same distance from the second base wall 48 so that the lowermost surfaces of the tabs 82 and tongues 94 lay in an imaginary plane that is parallel to a plane defined by the second base wall 48. Preferably, the tongues 94 are formed as a unitary portion of the second housing member 22 during the molding process that creates the second housing member 22.

As best seen in FIG. 1, each of the cases 12 further includes a closure latch 96 extending from the first and second front walls 34 and 44 to selectively retain each of the storage cases in a closed condition with the first and second housing members 20 and 22 in the closed position. While any suitable closure latch can be used, many of which are known, in the illustrated and preferred embodiments, the closure latch 96 is mounted to second front wall 44 to translate relative to the first and second front walls 34 and 44 as indicated by Arrow A in FIGS. 1 and 4 between a retaining position (shown in FIG. 1) wherein the latch 96 engages mating structure 97 on the first housing member 20 to retain the first and second housing members 20 and 22 in the closed position and a releasing position (shown in phantom in FIG. 4) wherein the latch 97 is disengaged from the mating structure 97 so that the first and second housing members can be moved to the open position from the closed position. In this regard, as best seen in FIG. 9, each of the second housing members 22 includes a guide rail structure 98 that is received in a guide slot 100 formed in the latch 96 to allow sliding translation of the latch 96 along the rail structure 98 between the retaining and released positions. Preferably, as best seen in FIG. 9, each case further includes a biasing member in the form of a helical compression spring 102 that is sandwiched between the second housing member 22 and the latch 96 to bias the latch to the retaining position.

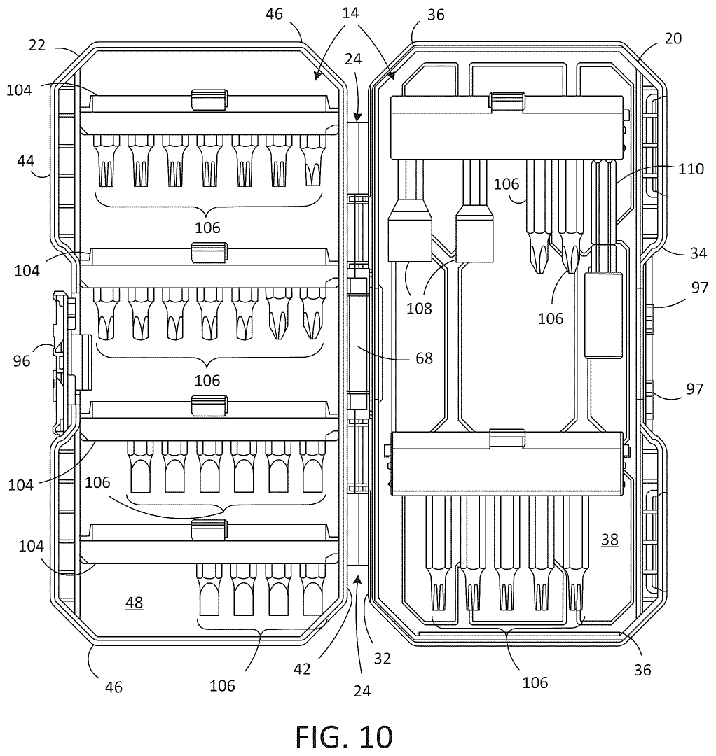

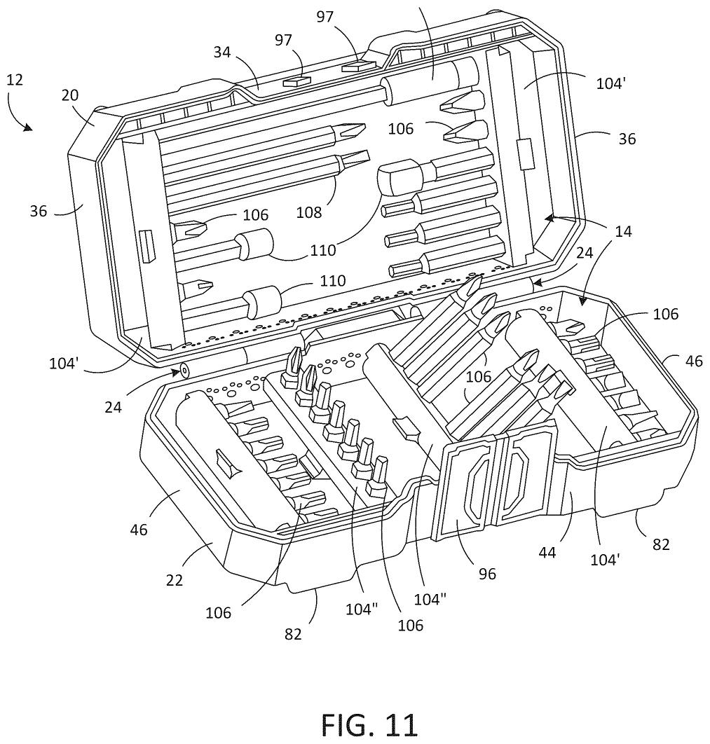

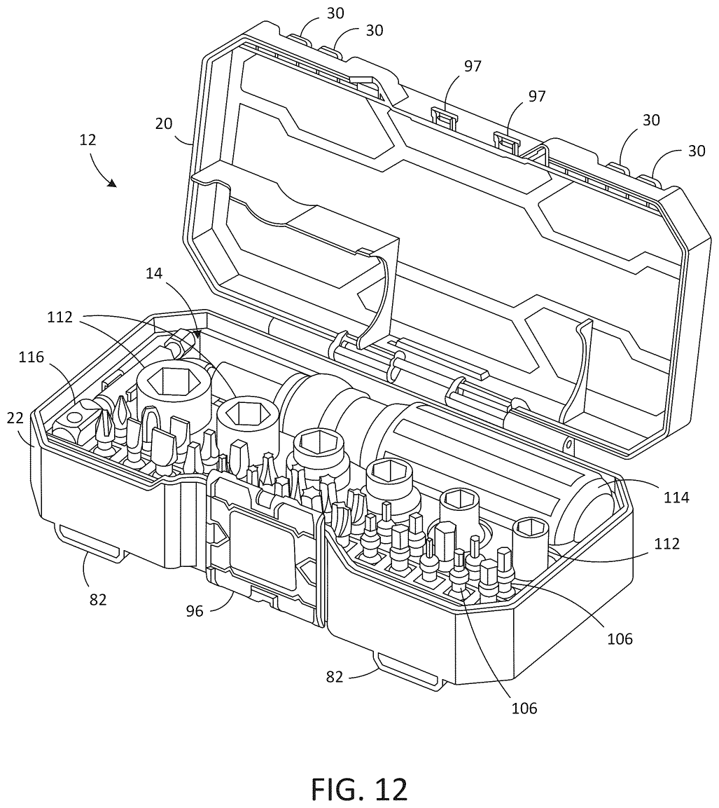

Each of FIGS. 10-12 show the cases 12 in the disconnected condition with the first and second housing members 20 and 22 in the open position. FIGS. 10 shows one of the cases 12 further including a plurality of bit holding members 104 mounted in each of the first and second housing members 20 and 22, with a variety of fastener driver bits 106, power nut drivers 108 and an adapter 110 releasably held in the members 104. Fig., 11 shows another one of the cases 12 with a different arrangement of the bit holding members 104 and a different variety of bits 106 and adapters 110. As seen in FIG. 11, the holding members 104 can be mounted in the case 12 to pivot between a stowed position (shown by members 104′) and an access position (shown by members 104″). FIG. 12 shows another one of the cases 12 with another variety of fastener driver bits 106, a variety of nut driving sockets 112, a driver handle 114 configured to receive each of the driver bits 106, and an adaptor 116 configured to engage each of the sockets 112 and to be received in the driver handle 114.

Preferred embodiments of the inventive concepts are described herein, including the best mode known to the inventor(s) for carrying out the inventive concepts. Variations of those preferred embodiments will become apparent to those of ordinary skill in the art upon reading the foregoing description. The inventor(s) expect skilled artisans to employ such variations as appropriate, and the inventor(s) intend that the inventive concepts can be practiced otherwise than as specifically described herein. Accordingly, the inventive concepts disclosed herein include all modifications and equivalents of the subject matter recited in the claims appended hereto as permitted by applicable law. Moreover, any combination of the above-described elements and features in all possible variations thereof is encompassed by the inventive concepts unless otherwise indicated herein or otherwise clearly contradicted by context. Further in this regard, while highly preferred forms of the cases 12 and system 10 are shown in the figures, it should be understood that this disclosure anticipates variations in the specific details of each of the disclosed components and features of the cases 12 and system 10 and that no limitation to a specific form, configuration, or detail is intended unless expressly and specifically recited in an appended claim.

For example, while specific and preferred forms have been shown for the general shape of each of the cases 12, other overall shapes may be used. For example, while each of the side walls 36 and 46 include angled portions that connect with the back and front walls 32, 34, 42, and 44, respectively, a more rectangular shape or a shape with more angled portions could be used. As another example, while four cleats 30 are shown, more or fewer cleats 30 could be desirable. Similarly, while four receptacles 40 are shown, more or fewer receptacles could be desirable. Furthermore, while specific configurations and shapes have been shown for the first and second connection structures 30 and 40, other configurations and shapes may be desirable. Accordingly, no limitations to the specific details of the illustrated embodiments should is intended unless expressly recited in an appended claim.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. The use of any and all examples, or exemplary language (e.g., “such as”) provided herein, is intended merely to better illuminate the inventive concepts disclosed herein and does not pose a limitation on the scope of any invention unless expressly claimed. No language in the specification should be construed as indicating any non-claimed element as essential to the practice of the inventive concepts disclosed herein.

All references, including publications, patent applications, and patents, cited herein are hereby incorporated by reference to the same extent as if each reference were individually and specifically indicated to be incorporated by reference and were set forth in its entirety herein.

What is claimed is:

1. A tool storage case system comprising:
a pair of storage cases that can be releasably connected to each other, each storage case defining an interior storage space and comprising:
a first housing member having a first connection structure, a first back wall, a first front wall, a pair of first side walls extending between the first front and first back wall, and a first base wall extending between the first wall, the first back wall and the pair of first side walls;
a second housing member having a second connection structure, a second back wall, a second front wall, a pair of second side walls extending between the second front and second back wall, and a first base wall extending between the second wall, the second back wall and the pair of second side walls;
a pair of hinges extending rearwardly from the first and second back walls and joining the first and second housing members to pivot relative to each other between an open position wherein the interior storage space can be accessed and a closed position wherein the interior storage space is enclosed by the housing members, the pair of hinges located on an exterior side of each of the first and second back walls;
a latch extending rearwardly from the exterior side of the second back wall no further than the pair of hinges, the latch located between the pair of hinges and mounted to the second back wall to pivot between a latched position and an unlatched position, the latch extending rearwardly no further than the pair of hinges with the latch in the latched position; and
a latch engagement structure located on the exterior side of the first back wall between the pair of hinges; and
wherein:
the pair of storage cases can be releasably connected to each other with the first connection structure of one of the storage cases of the pair of storage cases engaged with the second connection structure of the other storage case of the pair of storage containers, and the latch of the one of the storage cases of the pair of storage cases engaged with the latch engagement structure of the other storage case with the latch in the latched position.

2. The tool storage case system of claim 1 wherein:
the first connection structure of each storage case comprises a pair of spaced cleats formed on the exterior side of the first base wall; and
the second connection structure of each storage case comprises a pair of spaced receptacles formed on the exterior side of the second base wall that are sized to receive the pair of spaced cleats.

3. The tool storage case system of claim 2 wherein:
each of the cleats extends from the first base wall at a location adjacent the first front wall; and
each of the receptacles extends from the second base wall at a location adjacent to the second front wall.

4. The tool storage case system of claim 3 wherein:
each of the cleats extends above a recess formed in the first front wall; and
each of the receptacles is formed in a tab that is received in a corresponding one of the recesses with a corresponding one of the cleats received in the receptacle.

5. The tool storage case system of claim 1 wherein each storage case of the pair of storage cases further comprises a pair of spaced tongues extending from the second back wall, and wherein the tongues of one of the storage cases of the pair of storage cases are located to closely overlay a portion of the first back wall of the other storage case of the pair of storage cases with the pair of storage cases releasably connected to each other.

6. The tool storage case system of claim 1 wherein each storage case of the pair of storage cases further comprises an additional latch extending from the first and second front walls with the housing members in the closed position to retain the housing members in the closed position.

7. The tool storage case system of claim 6 wherein the additional latch of each storage case of the pair of storage cases is mounted to the second front wall to translate relative to the second front wall between a retaining position wherein the latch retains the first and second housing members in the closed position and a releasing position wherein the first and second housing members can be moved to the open position from the closed position.
